(19) United States
(12) Patent Application Publication
(10) Pub. No.: US 2017/0000044 A1
(43) Pub. Date: Jan. 5, 2017

(54) Crop Guardian - Crop Germinating and Growth in a Lined and Domed Furrow

(71) Applicant: Gerald R. Palmer, Phoenix, AZ (US)

(72) Inventor: Gerald R. Palmer, Phoenix, AZ (US)

(21) Appl. No.: 15/197,219

(22) Filed: Jun. 29, 2016

Related U.S. Application Data
(60) Provisional application No. 62/186,675, filed on Jun. 30, 2015.

(51) Int. Cl. A01G 13/02; A01G 7/04; A01C 5/06; A01G 25/02

(52) U.S. Cl. CPC A01G 13/0243; A01G 13/0281; A01G 13/0275; A01G 25/02; A01G 7/045; A01C 5/062

(57) ABSTRACT

The embodied invention utilizes a lined and domed furrow to provide for crop germinating and growth. The dome and soil lining provide for moisture control in the soil. The lining is an impermeable material, and bottom surface incorporates slits to allow plant roots to grow into the soil. The domed covering is a permeable material that covers the furrow by utilizing a domed shape wire frame spaced at intervals. A polyacrylate coating is optionally applied to the furrow cover. A drip irrigation system provides water to the soil mixture inside the lined furrow. The soil mixture includes a water absorbing polymer and an additional planting mediums. A light provides for warming the soil in the furrow to lengthen the growing season. The furrow geometry is shaped by a machine. The furrow shape will alter as the plant grows, in particular, the dome will expand.

### CROSS REFERENCE TO RELATED APPLICATIONS

This application claims the benefit of U.S. provisional patent application No. 62/186,675 filed on Jun. 30, 2015. The provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward crop and plant watering systems that are designed to use a low amount of water. It is particularly directed at crop growing methods that utilize a lined and covered furrow to minimize the amount of water needed.

(2) Description of Related Art

Farming has an important place in human history. The transition of humans from hunter-gatherer to settled, agricultural societies first began around 12,000 years ago. Changes in human farming practices over the centuries has reduced the percentage of people dedicated to growing food, allowing cities and civilizations to prosper and grow.

Currently, farmers can reduce water use by using better and more efficient irrigation equipment. An efficient system design depends primarily on the type of crop, soil, and local climate. Spray and gravity flow systems are just two examples of common solutions for more economical water use. Once an irrigation system is chosen, further water economy comes from an adaptive irrigation schedule which follows the weather. Also the farmer can reduce water by monitoring soil moisture, and then water crops as needed.

Efficient use of water in crop growing primarily requires minimization of evaporative loss, and secondarily, dispersion soil loss. Additional savings can come from minimizing the amount of soil that needs to be saturated with water; watering soil that does not contribute to the root system is ineffective.

Others have worked in this field. A few examples follow.

US 20120096767 is an example of experiments designed to uncover suitable plant growth mediums which enhance plant growth, allow the farmer to control precisely the nutrients to the plants, and are recyclable. Gerbera (trade name Yanara), English Cucumber, and Beef Steak Tomato plants are utilized to determine a recyclable growth medium. Unfortunately, the growth medium is expensive and unsuitable for mass production farming.

US 20070283621 describes a lined and covered plant row that is intended to germinate and grow crops, and protect a growing crop from weeds, pests, and diseases. Additionally, a machine that is used to plant seeds is described. However, it is not designed to lower the amount of water the crop utilizes by carefully controlling the plant row moisture environment. The cover is impregnable, and crop temperature control is difficult. The ground cover medium has the advantage of recyclable, but has the disadvantage of requiring frequent replacement.

U.S. Pat. No. 4,117,685 is a patent that grows a plant inside a pipe that is partially cut away. The desire is to irrigate plants and minimize evaporation and water loss into the surrounding soil. Unfortunately, the design includes significant expense by the use of a solid pipe, which is expensive and difficult to maintain in a large crop field.

What is needed is a crop growth space that minimizes the amount of water that is needed, controls the temperature of the plant environment, protects the crop from diseases and pests, is low maintenance, and affords economic crop production.

### BRIEF SUMMARY OF THE INVENTION

The present invention utilizes a lined and domed furrow to provide a space for crop germinating and growth. The dome and lining provide for moisture control in the soil mixture, limiting the amount of soil to be saturated. The furrow lining is an impermeable material, but the very bottom surface incorporates slits or punctures to allow the plant roots to grow into the soil below. The domed covering is a permeable material, such as cotton or a permeable plastic that covers the furrow by use of a domed shape, and a wire frame support it every four to six feet. A drip irrigation system provides water to the soil mixture inside the lined furrow. The soil mixture includes a water absorbing polymer and at least one additional potting medium which may be organic or inorganic. Suitable potting mediums include vermiculite, perlite, sand, silt, peat, charcoal, loam, fertilizer, compost, humus, manure, bone meal, blood meal, alfalfa meal, cottonseed meal, crab meal, feather meal, fish meal, soybean meal, kelp meal, granite meal, greensand, bat guano, seabird guano, colloidal phosphate, rock phosphate, wood ash, worm, castings, ground limestone, pine bark, sphagnum peat moss, coir, alfalfa, Kenaf, sawdust, ground newspaper, clay, and leaf mold.

A light is provided for warming the soil within the furrow, and to provide a longer growing season. The ground is shaped by a machine with a tool that provides the furrow shape when moving. The crop growing space will alter as the plant grows, in particular, the dome will expand.

Enhancements to the basic furrow include a method of capturing moisture on the dome to add moisture to the soil. If there is fog, mist, or a high humidity, the top cover will trap and allow the moisture to pass into the domed and lined furrow.

### BRIEF DESCRIPTION OF THE SEVERAL VIEWS OF THE DRAWING(S)

FIG. 1 is a side view of a desirable furrow design.

FIG. 2 is another side view of a furrow design when at least some water is provided by an adjacent salt or brackish water basin.

FIGS. 3A-3B are similar to FIG. 1 and show another furrow design shape.

FIG. 4 shows the concept of watering in phases depending upon the growth of the plant.

FIGS. 5A-5D show alternate embodied geometries for the plant furrow and frame geometry based on the type of plant that will be grown.

### DETAILED DESCRIPTION OF THE INVENTION

The advantages of the embodied invention include:

1. Provides a plant environment reduces fertilization, and insecticides by up to 80%.

2. Provides a plant embryo environment that protects and nourishes seedlings.

3. Provides up to 80% reduction in water use.

4. Provides reduction in irrigation periods.

5. Increases the growing season by 2-4 weeks (or more).

6. Protects plant seedlings from frost, wind, sun and hail.

7. Protects plant from birds and insects

8. Reduces water evaporation by sun and wind.

9. Provides for passive self-ventilating during hot periods while maintaining a growth environment.

10. Extends the growing season with an optional light design (provides frost free protection and higher soil temperature), important for latitudes like Alaska.

11. Maintains soil moisture in the 30-70% range for extended periods.

12. Captures atmospheric moisture with a condensate option and makes it available for plant growth.

13. Extends farming to many locations currently unfavorable due to soil, latitude, weather, or water conditions.

14. Uses soft water for irrigation.

15. An optional use of sea water or brackish water to supplement or replace irrigation.

In one embodiment, this method only uses atmospheric moisture or evaporation.

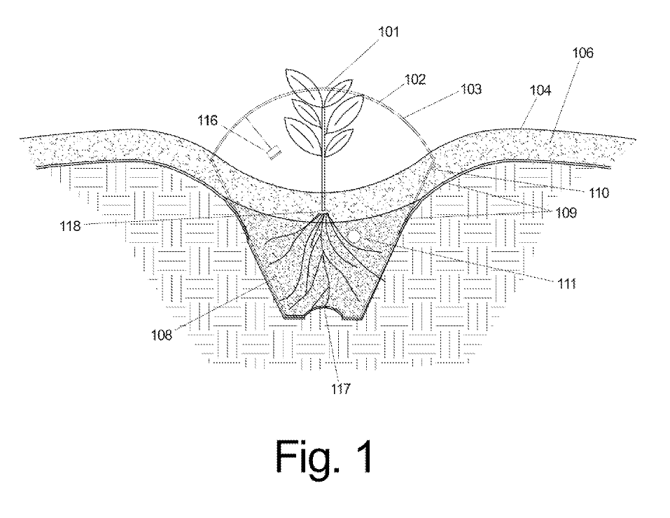

FIG. 1 shows the features of the furrow design for a planted seed:

FIG. 1

| No. | Description |
|---|---|
| 101 | Crop Penetration through top cover |
| 102 | Optional Cover Vent |
| 103 | Top Cover |
| 104 | Finish Grade Original Soil |
| 106 | Dirt Cover (2 ½-3″) |
| 108 | Planting Soil Mix |
| 109 | Plastic Ground Cover |
| 110 | Wire Frame |
| 111 | Drip Line |
| 116 | Light (LED or Incandescent) on a |
| | Tape or Rope for growth or heat |
| 117 | Tap Root Penetration |
| 118 | Seed or seed Tape |

The top cover 103 is made from an impermeable plastic or cloth and is installed onto a metal frame. The cloth may incorporate a coating that is useful for trapping moisture. The metal frame is a loop shape as indicated, and installed approximately every 4-6 feet. The top cover 103 acts like a solar screen and prevents evaporation. It also protects from birds, bugs, wind, hail and frost.

The crop penetrates 101 through the top cover which includes perforations that are designed to allow the plant to penetrate as it grows larger.

An optional cover vent 102 opens to control the air temperature underneath the cover when it is too hot. This is especially useful when the top cover 103 is an impermeable plastic. If the top cover is a permeable material, a vent may or may not be needed depending upon the temperature underneath the top cover.

A finished grade from original soil 104 is shaped into a furrow as illustrated.

The planting soil mix 108 is made from a combination of native soil, a water absorbing polymer, and at least one additional potting medium which may be organic or inorganic. Suitable potting mediums include vermiculite, perlite, sand, silt, peat, charcoal, loam, fertilizer, compost, humus, manure, bone meal, blood meal, alfalfa meal, cottonseed meal, crab meal, feather meal, fish meal, soybean meal, kelp meal, granite meal, greensand, bat guano, seabird guano, colloidal phosphate, rock phosphate, wood ash, worm, castings, ground limestone, pine bark, spaghnum peat moss, coir, alfalfa, kenaf, sawdust, ground newspaper, clay, and leaf mold. In one embodiment, the water absorbing polymer gel is a polyacrylate. A product name for this is “Stockosorb 660”. Alternately, other water absorbing polymers (PAM) could be used.

As a practical matter a seed or seed tape 118 is used to establish the plant. This is a convenient way to plant crops a desired distance apart.

An impervious plastic ground cover 109 controls water migration to the soil below, and prevents bugs.

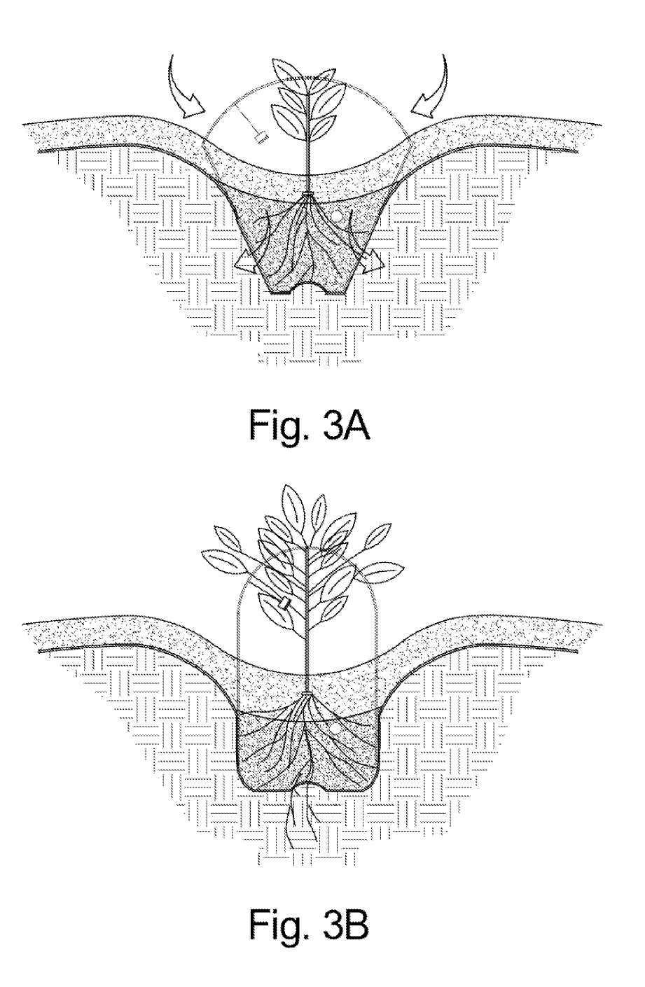

The wire frame 110 is made from galvanized wire and moves outwardly as the plant grows. This is illustrated in FIGS. 3A-3B.

A drip line 111 with drip emitters are installed on the drip line at intervals to control the volume of water into the furrow, and is optionally pressure compensated. Drip emitters are installed at intervals along the length of the furrow. A drip emitter is preferably a pipe with spaced slots or an orifice.

An incandescent or L.E.D. light 116 is used to provide light and increase the soil temperature frost protection from the heat generated by the light. This is especially useful in extending the growing season by providing earlier seed germination with warmer ground temperatures during the colder weather and when there is a lesser amount of sunlight. The light could be powered by a high or voltage, and is optionally solar powered. Some important crops germinate at 56° F.

A portion of the plastic ground cover is slotted 117 to allow the plant roots to push through.

A lower watering area receives water after plant roots push through the plastic ground cover. Crop watering is phased in as the plant grows. The amount of water used depends upon a number of factors, including the plant maturity, amount of rainfall, and the time of year.

The embodied invention also reduces fertilizer consumption because there is less runoff and migration into the lower soil. Similarly, the amount of pesticide is reduced due to lower watering on the top of the crop, and the top cover helps to prevent pests.

If the plant crops are located near seawater, the seawater can be purified to usable water for crops by a method known in the art. The need for a low amount of water per acre of crop reduces volume required for watering when a sea-water or brackish water is used.

Purified water can be generated by a mechanical filter system, a distillation system, a solar based evaporative system, or a chemical processing method to remove impurities and ions to make it suitable for use. Chemical processing systems include distillation, capacitive deionization, reverse osmosis, carbon filtering, microfiltration, ultrafiltration, ultraviolet oxidation, and electro-deionization.

The top cover acts as a solar shield and protects the crop from snow and hail. It alsoreduces water evaporation by 10 To 15% by protecting the crop from wind and sun. It also is able to extend the growing system up to 12 weeks by protecting the plants from frost, freezing, and hail.

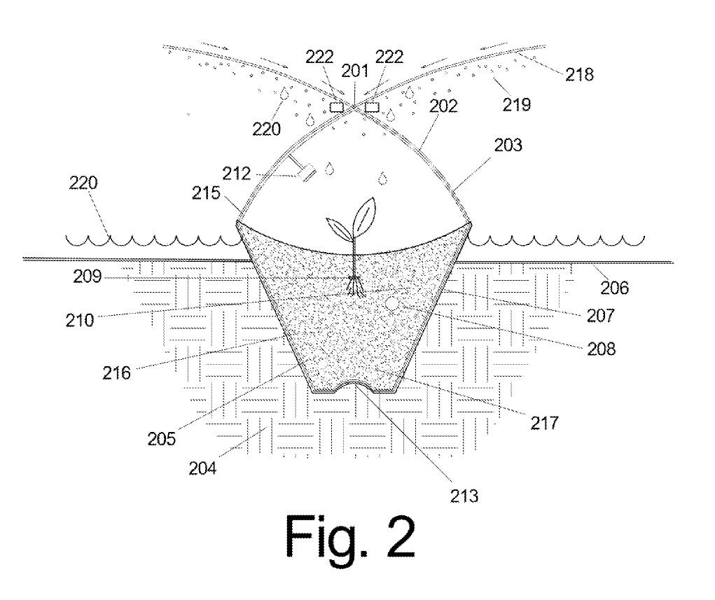

FIG. 2 shows the features of the furrow design, situated in a saltwater or brackish water field, designed similarly to FIG. 1.

FIG. 2

| No | Description |
|---|---|
| 201 | Crop Penetration |
| 202 | Optional Cover Vent |
| 203 | Top Cover Over Wire Frame |
| 204 | Finish Grade Original Soil |
| 205 | Planting Soil Mix |
| 206 | Plastic Ground Cover |
| 207 | Wire Frame |
| 208 | Drip Line |
| 209 | Seed tape |
| 210 | Riser |
| 212 | Light (LED or Incandescent) |
| | on a Tape or Rope |
| 213 | Tap Root Penetration |
| 218 | Plastic coated cloth (Dewetting) |
| 219 | Small Water Vapors |
| 220 | Condensate-Fresh Water Drips |
| 222 | Polymer Nano Carbon Tubes |

The top cover 203 is made from an impermeable plastic or cloth and is installed onto a metal frame. The cloth may incorporate a coating that is useful for trapping moisture. The metal frame is an elongated loop shape as indicated, and installed approximately every 4-6 feet. The top cover 203 acts like a solar screen and prevents evaporation. It also protects from birds, bugs, wind, hail and frost.

The crop penetrates 201 through the top cover which is designed to allow the plant to penetrate as it grows larger.

An optional cover vent 202 opens with higher temperature to control the air temperature underneath the cover. This is especially useful when the top cover 203 is an impermeable plastic. If the top cover is a permeable material, a vent may or may not be needed depending upon the temperature underneath the top cover.

The original soil 204 is shaped as indicated. The planting soil mix 205 is made from a combination of native soil, a water absorbing polymer, and at least one additional potting medium which may be organic or inorganic. Suitable potting mediums include vermiculite, perlite, sand, silt, peat, charcoal, loam, fertilizer, compost, humus, manure, bone meal, blood meal, alfalfa meal, cottonseed meal, crab meal, feather meal, fish meal, soybean meal, kelp meal, granite meal, greensand, bat guano, seabird guano, colloidal phosphate, rock phosphate, wood ash, worm, castings, ground limestone, pine bark, spaghnum peat moss, coir, alfalfa, kenaf, sawdust, ground newspaper, clay, and leaf mold. In one embodiment, the water absorbing polymer gel is polyacrylate. Other water absorbing polymers (PAM) could alternately be used.

The original soil 204 is shaped into a furrow as illustrated. The soil is left undisturbed as much as practical.

An impervious plastic ground cover 206 controls water migration to the soil below, and prevents bugs. Only a temporary protection is needed for a young plant. Young plant roots are more vulnerable, but later in the growth cycle, the plant roots do not need the protection.

The wire frame 207 is made from galvanized wire and moves outwardly in a natural manner when the plant grows. An optional friction release can be added to the wire frame at the soil level to allow the upper portion of the frame to disconnect from the lower portion of the frame. This allows the frame to expand more easily and allow room for the plant to grow. It additionally provides an extended period of frost protection.

As a practical matter a seed tape 209 is used to establish the plant. This is a convenient way to plant crops a desired distance apart.

A drip line 208 provides controlled amounts of water as needed to saturate around plant roots only. The drip emitter is used to control the volume of water into the furrow, and is optionally pressure compensated. Drip emitters are installed at intervals along the length of the furrow. The drip emitter is preferably a pipe with spaced slots or an orifice.

The irrigation system is used whenever the water condensate from the adjacent seawater, (or brackish) basin does not provide adequate moisture for crop growth. Water condensate can come from fog, dew, or high humidity as well.

An incandescent or L.E.D. Light 212 mounted on a tape is used to provide light and increase the soil temperature from the heat generated by the light. This is especially useful in extending the growing season by providing earlier seed germination with warmer ground temperatures during the colder weather and when there is a lesser amount of sunlight. The light could be powered by a high or low voltage, and is optionally solar powered.

A portion of the plastic ground cover is slotted 213 to allow the plant roots to push through.

The moist atmosphere (misty or highly humid) above the water collects small water vapors 219 onto a fabric coated with a polyacrylate de-wetting system 218, which collects the water vapors into drops of fresh condensate 220 onto the top cover. The water then drops below the cover and waters the plant. Polymer Carbon Nano Tubes 222 assist the water formation.

FIGS. 3A-3B show how the furrow dimensions expand and grow based on the growth of the plant root system. The initial furrow geometry is not held in place by rods or stakes that are anchored into the soil. Instead, the initial furrow geometry is allowed to change based on the pressure of the root ball and the wire frames that support the top cover are allowed to move when the sides of the furrow move.

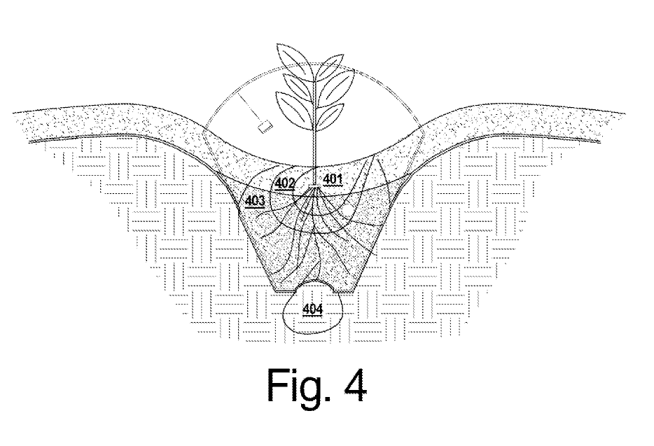

FIG. 4 shows the concept of watering in phases depending upon the growth of the plant. In phase I, the watering schedule is restricted so that only the immediate area around the seed or root ball receives the moisture needed for germination/ growth.

As an alternate embodiment, the polyacrylate could be a polymer that would satisfy the definition of organic farming. Such a polymer could be Polysaccharide (which is a modified cellulose/sugar/starch base PAM like “Biosap”). This would allow the methods taught in this disclosure to reach a broader farming market, and an important one for many consumers.

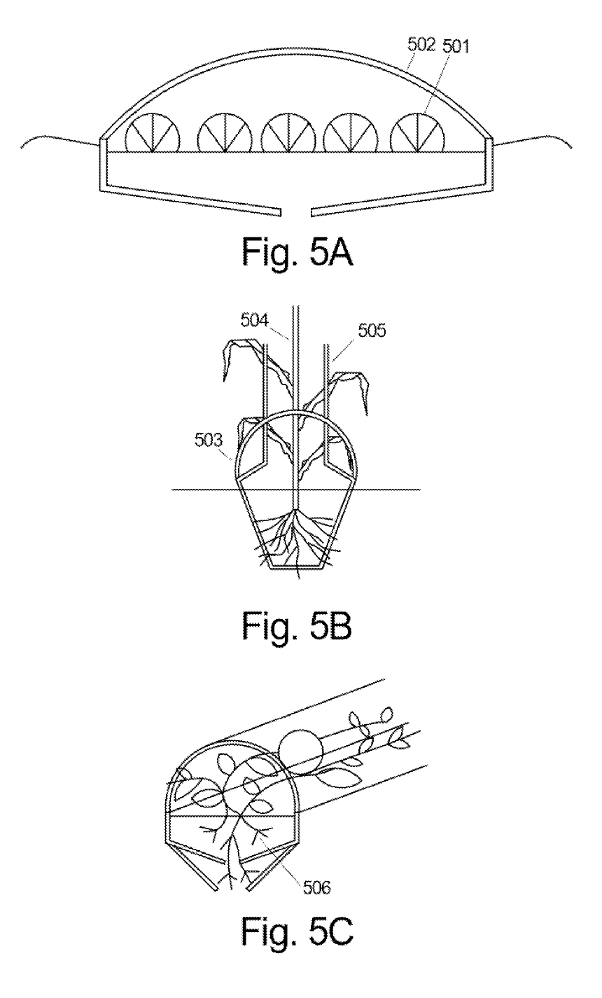

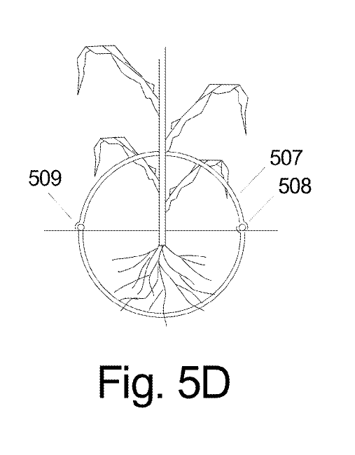

FIGS. 5A-5C show alternate embodied geometries for the plant furrow and frame geometry based on the type of plant that will be grown. In FIG. 5A, typical rows of strawberries, cabbage, lettuce (Type A) 501 can be grown under the cover and in the furrow geometry. Multiple grouping of the crop furrows remain under the crop cover 502.

In FIG. 5B, tomato type produce including fruit trees, and corn, are grown under the cover 503 and in the furrow geometry. The plant penetrates the plastic ground cover at the root system. The plant stalk grows through 504 the domed cover. An optional metal frame support 505 can be included for tomato type produce to support the plant.

In FIG. 5C, root type produce, such as potatoes are grown under the cover. The plant remains under cover and in the furrow geometry. This type of arrangement is suitable for root plants 506 such as potatoes, melons, and squash.

In FIG. 5D, a reusable wire cage 3″×3″ grid 507 is hinged 508 to allow the lid to open for access. A latch pin 509 is used to keep the lid closed.

While various embodiments of the embodied invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A crop furrow that is self-supporting without staking and is designed to provide germinating and growth for a crop comprising:
A) a crop furrow shaped by soil geometry and a soil lining, wherein said crop furrow is covered with a dome covering,
B) wherein said dome covering and said soil lining are designed to provide soil moisture control,
C) wherein said soil lining is made from an impermeable material,
D) wherein a bottom of said soil lining incorporates slits or punctures,
E) wherein said dome covering is a permeable material,
F) wherein said permeable material is a cotton or a permeable plastic,
G) wherein said dome covering is supported by a wire frame approximately every four to six feet,
H) a composite mixture located within said crop furrow, wherein said composite mixture comprises soil, a water absorbing polymer, and an additional planting medium,
I) a drip irrigation system that is designed to provide water to said composite mixture,
J) an optional light installed underneath said dome covering, wherein said optional light provides for both lighting and heat to said composite mixture, and
K) wherein said composite mixture is monitored for moisture, wherein control of said moisture is provided by said drip irrigation system,
whereby said composite mixture is controlled for both moisture and temperature to provide said crop germinating and growth.

2. The crop furrow according to claim 1 wherein a machine is used to create said soil geometry and install said soil lining.

3. The crop furrow according to claim 1 wherein said dome lining expands as said crop grows in height.

4. The crop furrow according to claim 1 wherein said cotton incorporates a coating that will switch between hydrophilic and hydrophobic properties based upon an ambient temperature.

5. The crop furrow according to claim 4 wherein said coating is a polyacrylate.

6. The crop furrow according to claim 1 wherein said water originates from a seawater or brackish basin adjacent to said crop furrow.

7. The crop furrow according to claim 1 wherein said additional planting medium comprises vermiculite, perlite, sand, silt, peat, charcoal, loam, fertilizer, compost, humus, manure, bone meal, blood meal, alfalfa meal, cottonseed meal, crab meal, feather meal, fish meal, soybean meal, kelp meal, granite meal, greensand, bat guano, seabird guano, colloidal phosphate, rock phosphate, wood ash, worm, castings, ground limestone, pine bark, spaghnum peat moss, coir, alfalfa, kenaf, sawdust, ground newspaper, clay, and leaf mold.

8. The crop furrow according to claim 1 wherein said optional light is designed to provide for a temperature increase in said composite mixture to provide for earlier germination of a plant seed.
